(19) United States
(12) Patent Application Publication
(10) Pub. No.: US 2025/0229208 A1
(43) Pub. Date: Jul. 17, 2025

(54) FRAMED AIR FILTER COMPRISING PLEATED FILTER ELEMENT WITH EDGE SEALS AND A PERIMETER SEAL

(71) Applicant: 3M INNOVATIVE PROPERTIES COMPANY, St. Paul, MN (US)

(72) Inventors: Andrew R. Fox, Oakdale, MN (US); Jeffrey A. Chambers, Minneapolis, MN (US); Mark A. Sanocki, Vadnais Heights, MN (US); Laszlo Titkos, Shoreview, MN (US)

(21) Appl. No.: 18/987,085

(22) Filed: Dec. 19, 2024

Related U.S. Application Data
(60) Provisional application No. 63/621,202, filed on Jan. 16, 2024.
(60) Provisional application No. 63/680,372, filed on Aug. 7, 2024.

(51) Int. Cl. B01D 46/52; B01D 46/10

(52) U.S. Cl. CPC B01D 46/521; B01D 46/10; B01D 2271/02

(57) ABSTRACT

A framed air filter including a pleated filter element with two opposing primary, corrugated edges and with two opposing secondary, non-corrugated edges. The pleated filter element bears two edge seals of hardened adhesive that are positioned proximate, and laterally inward from, each primary, corrugated edge. The framed air filter includes a perimeter seal that is made of hardened adhesive and that is disposed on the first side of the pleated filter element. The frame of the framed air filter may be a flattenable-as-made frame.

### CROSS REFERENCE TO RELATED APPLICATIONS

This application claims priority from U.S. Provisional Application Ser. No. 63/621,202, filed 16 Jan. 2024 and U.S. Provisional Application Ser. No. 63/680,372, filed 7 Aug. 2024, the disclosure of which is incorporated by reference in its/their entirety herein.

### BACKGROUND

Air filters are commonly used in powered air-handling apparatus, e.g. residential and commercial heating and air-conditioning (HVAC) systems, room air purifiers, and so on, in order to remove fine particles, dust and debris, and so on.

### SUMMARY

In broad summary, herein is disclosed a framed air filter comprising a pleated filter element with two opposing primary, corrugated edges and with two opposing secondary, non-corrugated edges. In one aspect, the pleated filter element may comprise two edge seals of hardened adhesive that are positioned proximate, and laterally inward from, each primary, corrugated edge. In another aspect, the framed air filter may comprise a perimeter seal that is comprised of hardened adhesive and that is disposed on the first side of the pleated filter element. In another aspect, the frame of the framed air filter may be flattenable-as-made. These and other aspects will be apparent from the detailed description below. In no event, however, should this summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view of an exemplary framed air filter.

FIG. 2 is a perspective exploded view of the framed air filter of FIG. 1.

FIG. 3 is a perspective view of an exemplary filter frame.

FIG. 4 is a plan view of an exemplary blank from which a filter frame can be formed.

FIG. 5 is a perspective view of an exemplary pleated filter element bearing edge seals.

FIG. 6 is a side view of the exemplary pleated filter element of FIG. 5.

FIG. 7 is a magnified perspective view of a portion of the pleated filter element of FIG. 5.

FIG. 8 is a side view of an exemplary pleated filter element.

FIG. 9 is a photograph of a portion of a first side of an exemplary framed filter prototype.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “top”, bottom”, “upper”, lower”, “under”, “over”, “up” and “down”, and so on, may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring absolute precision or a perfect match. The term “substantially”, unless otherwise specifically defined, means to a high degree of approximation but again without requiring absolute precision or a perfect match. The term “essentially” means to a very high degree of approximation: it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match.

As defined herein, a “first” major side of a framed air filter having a perimeter seal, will be the side of the framed air filter that bears the perimeter seal, as described in detail later herein. A “second” major side of the framed air filter will be the other, opposing side.

Terms such as “outer”, “outward”, “outwardmost”, “outwardly”, and the like, refer to directions generally aligned with the major plane of the framed filter, that are generally away from the geometric center of the framed filter. Terms such as “inner”, “inward”, “inwardmost”, “inwardly”, and the like, refer to directions generally aligned with the major plane of the framed filter, that are generally toward the geometric center of the framed filter. The term “lateral”, and terms such as a “lateral axis” of the framed filter, “laterally inward”, “laterally outward”, and so on, denote directions that are generally aligned with the Pleat Direction of a pleated air filter element, as discussed in detail herein.

### DETAILED DESCRIPTION

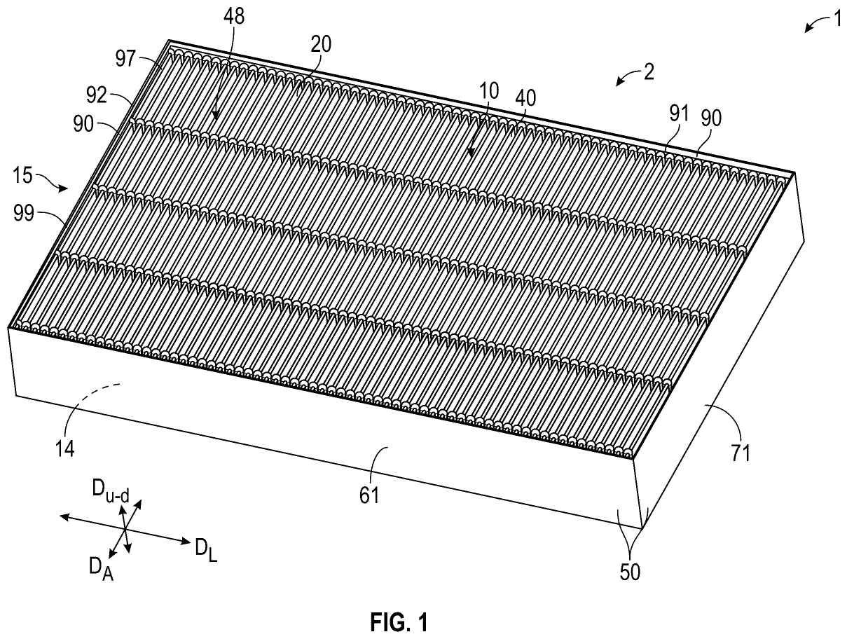

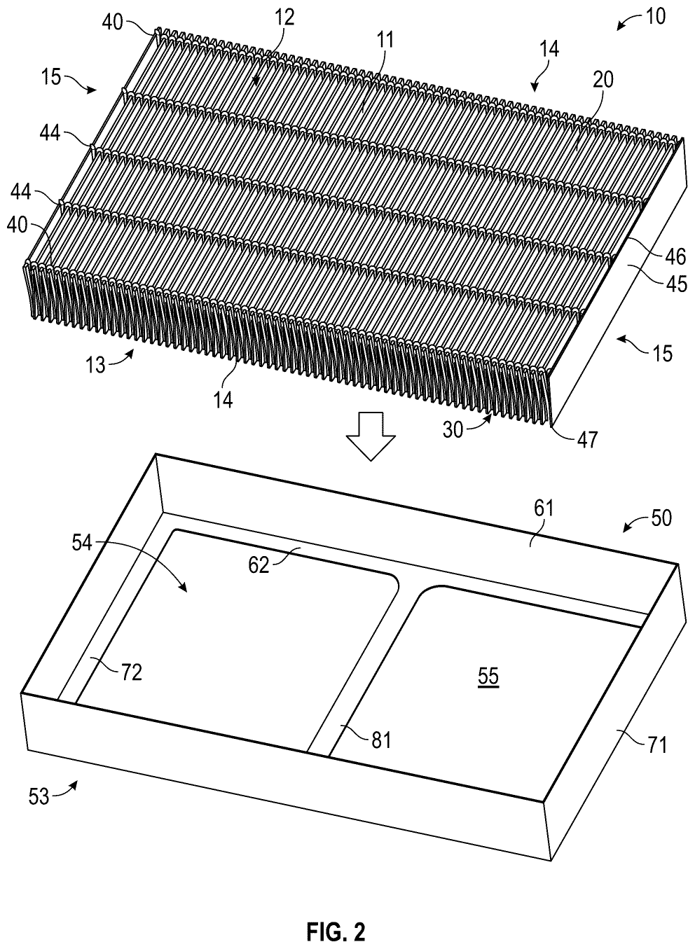

Shown in FIG. 1 in perspective view is an exemplary framed air filter 1 as disclosed herein. Framed air filter 1 comprises a first major side 2 and a second major side 3, with first major side 2 comprising a perimeter edge seal 40. Framed air filter 1 comprises a pleated air filter element 10 and a perimeter frame 50 that extends around all four sides of the pleated air filter element 10. Pleated air filter element 10, perimeter frame 50, and framed air filter 1, will all be at least generally rectangular in shape (which specifically includes square shapes), so that the framed air filter 1 comprises four corners. As evident in the exploded perspective view of FIG. 2, pleated air filter element 10 resides in a filter-element-receiving space (receptacle) 54 of perimeter frame 50. Pleated air filter element 10 comprises first major side 12 and second major side 13, along with first and second opposing primary, corrugated edges 14, and first and second opposing secondary, non-corrugated ends 15. (For consistency of description, the term “edges” will be used to refer to corrugated edges 14 and the term “ends” will be used to refer to non-corrugated ends 15.)

### Perimeter Frame

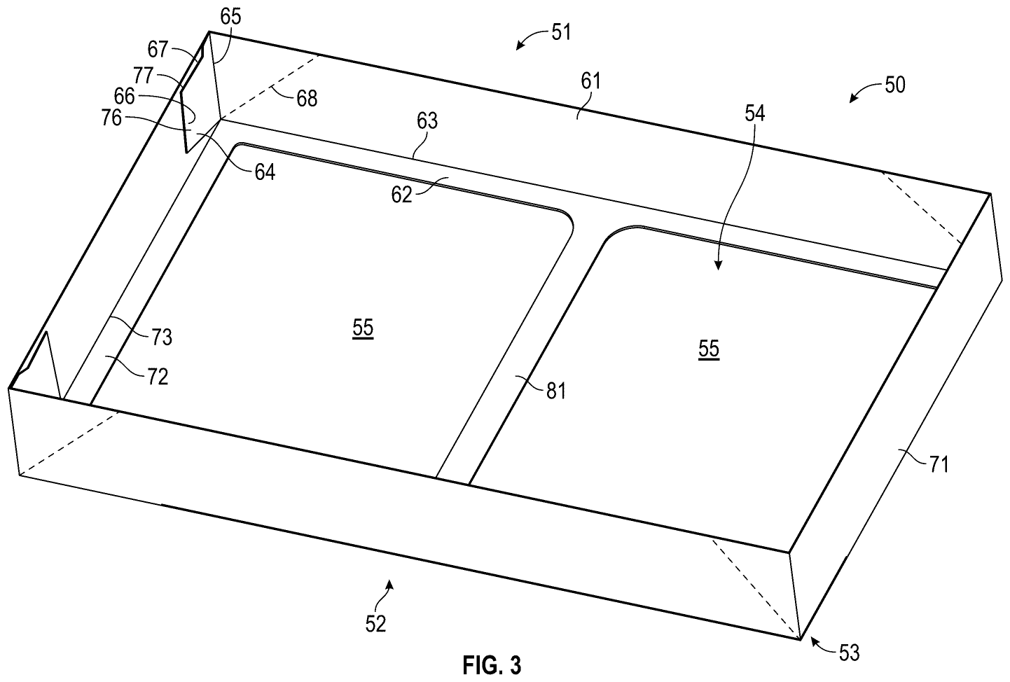

Perimeter frame 50, as shown in isolated perspective view in FIG. 3, comprises first and second major sides 51 and 52 and comprises first and second opposing primary sidewalls 61 that, in the assembled framed filter, are positioned outward of the first and second opposing primary, corrugated edges 14 of pleated air filter element 10. Perimeter frame 50 further comprises first and second opposing secondary sidewalls 71 that, in the assembled framed filter, are positioned outward of the opposing secondary, non-corrugated ends 15 of pleated air filter element 10.

In the depicted embodiment, the second major side 52 of perimeter frame 50 comprises first and second opposing primary flanges 62 that, in the assembled framed filter, abut laterally-outermost portions of second-side pleat tips 31 of pleated air filter element 10. Second major side 52 of perimeter frame 50 further comprises first and second opposing secondary flanges 72 that, in the assembled framed filter, abut the first and second opposing secondary, non-corrugated ends 15 of pleated air filter element 10. As is apparent from FIGS. 2 and 3, in the depicted design, frame 50 does not comprise any such primary and/or secondary flanges on the first major side 51 of the frame. Accordingly, in many convenient embodiments, a framed air filter 1 can be assembled by taking a filter element 10, e.g. in the form of a pre-made “pleatpack” that is already in a stable, pleated configuration, that bears edge seals 40 as discussed in detail later herein, and so on, and inserting the pleatpack into the first, open end of perimeter frame 50 in the manner indicated by the block arrow in FIG. 2, so that filter element 10 is seated within the receiving space 54 of perimeter frame 50. A perimeter seal 90 can then be applied to the first major side 12 of filter element 10 to secure filter element 10 in place within perimeter frame 50 and for other purposes as discussed later herein.

Perimeter frame 50, as shown in isolated perspective view in FIG. 3, thus takes the form of a rectangular frame with two opposing primary sidewalls 61, two opposing secondary sidewalls 71, two opposing second-side primary flanges 62, and two opposing second-side secondary flanges 72. The second side 52 of frame 50 defines a second-side active air-filtration area 55 through which filtered air will pass upon exiting the pleated filter element 10. In many embodiments, second-side active air-filtration area 55 will be laterally bounded by laterally-inward edges of primary flanges 62 and by longitudinally-inward edges of secondary flanges 72, acting in combination. In some embodiments, the second side 52 of frame 50 may comprise at least one second-side strut 81 that crosses at least a portion of active air-filtration area 55. Such a strut or struts 81 may enhance the structural rigidity of frame 50 and of framed air filter 1, without unacceptably reducing the airflow through the filter element.

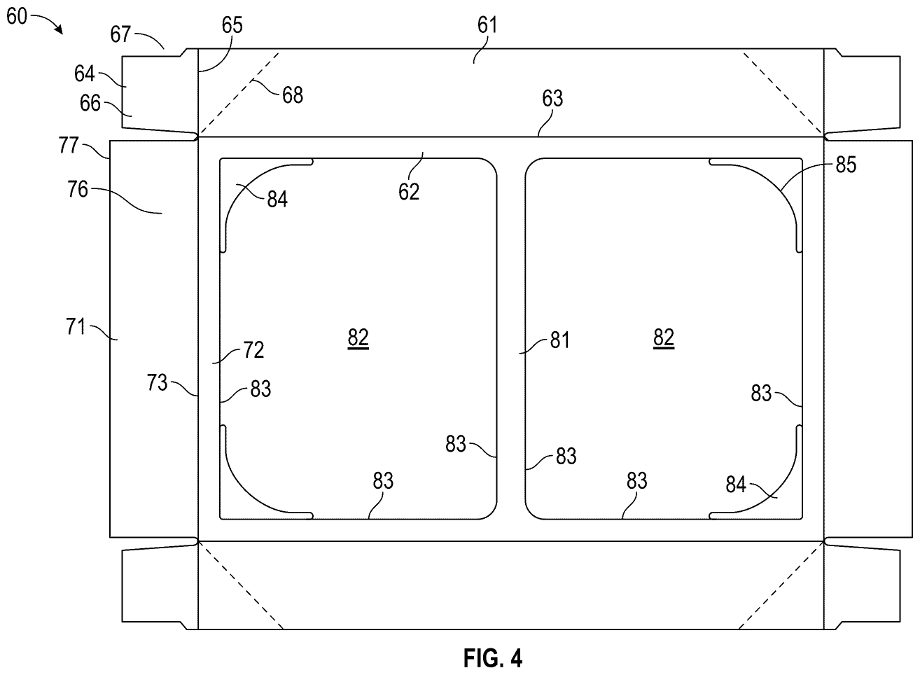

In many convenient embodiments, frame 50 may be a single-piece frame, meaning that it is formed from a single, integral, planar, sheet-like entity 60 (often referred to as a “blank”) from which frame 50 is formed by various cutting and folding operations. Such a blank, as exemplified by blank 60 as depicted in FIG. 4, will comprise multiple panels (each of which typically remains planar, both in the blank 60 itself and in the resulting frame 50 formed therefrom) that are integrally, foldably connected by fold lines. For example, the panels 61 of blank 60 that will become the above-described primary sidewalls of the resulting frame are integrally connected to the panels 62 that will become the above-described primary flanges of the resulting frame, by fold lines 63. Similarly, the panels 71 that will become the secondary sidewalls are integrally connected to the panels 72 that will become secondary flanges, by fold lines 73. Folding these panels along these fold lines (to a fold angle of approximately 90 degrees) will thus provide a perimeter frame of the general type shown in FIG. 3, the frame having primary and secondary sidewalls and the second side of the frame having primary and secondary flanges.

Additional features and elements may be provided that allow the primary and secondary sidewalls of the frame to be attached to each other. In the depicted embodiment, each primary sidewall/panel 61 comprises a corner-bonding tab 64 that is integrally, foldably connected to an end of primary sidewall 61 by a fold line 65. When primary sidewall 61 and secondary sidewall 71 are folded into position to form frame 50, tab 64 can be folded to a fold angle of approximately 90 degrees relative to primary sidewall 61 along fold line 65 so that a bonding area 66 of corner-bonding tab 64 will overlap a complementary bonding area 76 of secondary sidewall 71 as evident in FIG. 3. Bonding areas 66 and 76 can then be bonded together by any suitable mechanism (e.g., a bonding adhesive disposed between areas 66 and 76, one or more mechanical fasteners such as staples, etc.) to attach primary sidewall 61 to secondary sidewall 71. Performing this at all four corners will cause frame 50 to form and maintain a rectangular shape. In many embodiments, corner-bonding tab 64 may inwardly abut secondary sidewall 71 (as in the depiction of FIG. 3); however, in other embodiments, tab 64 may be positioned outwardly of secondary sidewall 71. In further acceptable variations, such a corner-bonding tab may integrally and foldably extend from an end of a secondary sidewall rather than from an end of a primary sidewall.

In some embodiments, additional features and elements may be provided that allow a perimeter frame 50 to be fully assembled (i.e. into the form depicted in FIG. 3) and then to be collapsed into a flattened configuration. This can allow multiple frames 50 to be produced, flattened, and then shipped and stored in a conveniently flat condition, with each frames being re-opened when it is desired to install a filter element in the frame. Thus for example, as depicted in FIGS. 3 and 4, auxiliary fold lines 68 can be provided at opposing ends of primary sidewalls 61 (so that there are four such auxiliary fold lines 68 in total), to allow the frame to be flattened in the desired manner. Each auxiliary fold line 68 originates from a corner 53 of frame 50; specifically, from a position that is located on the second side 52 of frame 50, proximate a junction of the inward end of primary sidewall 61 with an inward end of secondary sidewall 71. (Such a location may often be very close to a second-side end of an above-described fold line 65 that integrally connects a corner-bonding tab 64 to an end of primary sidewall 61, as evident from FIGS. 3 and 4.) Such an auxiliary fold line 68 will extend generally linearly and diagonally along primary sidewall 61 until reaching a first-side terminal edge of primary sidewall 61. (In the depicted embodiment of FIGS. 3 and 4, each such auxiliary fold line 68 is oriented at an angle of approximately 45 degrees relative to fold line 65 that integrally connects corner-bonding tab 64 to the end of primary sidewall 61.)

Once a perimeter frame 50 is assembled into a configuration as in FIG. 3, the primary sidewalls 61 can be urged inwardly (rotating about fold lines 63). The auxiliary fold lines 68 will allow this process to be performed such that primary sidewalls 61 collapse at least generally flat against the primary flanges 62. This process will similarly cause secondary sidewalls 71 to collapse inwardly (rotating about fold lines 73) toward secondary flanges 72 so that secondary sidewalls 71 collapse at least generally flat against secondary flanges 72. This will cause end portions of secondary sidewalls 71 (to which the above-described corner-bonding tabs 64 of primary sidewalls 61 are attached) to collapse atop end portions of primary sidewalls 61, as facilitated by auxiliary fold lines 68. Although the above-described fold lines 63, 65 and 73 need only allow folding to approximately 90 degrees in the finished, framed air filter 1 (as depicted in FIG. 3), in order to flatten and collapse the frame in the absence of a filter element, these fold lines must allow folding to an angle of approximately 180 degrees (i.e. so that the two entities that are joined at each fold line are able to collapse at least generally flat against each other).

That above-described arrangements can allow a large number of perimeter frames 50 to be assembled from blanks 60, then flattened and stacked for shipment and storage. Then, when it is desired to assemble framed air filters 1, each flattened frame 50 can be unfolded and a pleated filter element 10 inserted thereinto in the general manner depicted in FIG. 2. Thus, the process of installing a pleated filter element 10 into a perimeter frame 50 to produce a framed air filter 1 does not require the various portions of the perimeter frame 50 to be folded, bonded, attached to each other, or any similar operation, during or as an immediate precursor to the installation process. Rather, a flattened frame 50 is simply unfolded and a pleatpack 10 is inserted into receiving space 54 of the frame. It is emphasized that in many embodiments this framing procedure will take place in a factory where the framed air filters are assembled from pleatpacks and frames; moreover, in many such embodiments the frame will not be reusable. Such arrangements will thus be distinguished from arrangements in which an end user inserts a pleatpack into a reusable frame and periodically replaces the spent pleatpack with a fresh pleatpack, while using the same frame.

A frame of the general type described above will be referred to as flattenable-as-made. By this is meant that the frame, as initially manufactured, can be flattened e.g. for shipment and storage, and can later be unflattened and a pleatpack inserted therein. Once the pleatpack is attached to the now-unflattened frame (as described in detail elsewhere herein), the frame is no longer flattenable (hence the designation of flattenable-as-made). Such a frame will be distinguished from frames that are configured to e.g. collapse (and/or expand) along with a filter media that is secured to the frame. Specifically, a framed air filter 1 comprising a flattenable-as-made frame, will not be flattenable, foldable, collapsible (or expandable), in the manner of various expandable/collapsible framed air filters. From the descriptions and characterizations herein, it will be understood that an ordinary artisan will be able to recognize a frame that is flattenable-as-made (even with the frame having a pleatpack attached thereto so that the frame is no longer flattenable), e.g. by way of the presence of auxiliary fold lines 68 as described above. An ordinary artisan will thus be able to distinguish a flattenable-as-made from other types of perimeter frames.

In some embodiments, a flattenable-as-made frame 50 may vary at least somewhat from the exemplary arrangements described above. For example, in some embodiments, an auxiliary fold line 68 may be provided in a secondary sidewall 71 rather than in a primary sidewall 61. Such an auxiliary fold line 68 can be arranged, and can function, in the manner described above, except that it will facilitate the inward collapse of secondary sidewall 71 rather than primary sidewall 61 (primary sidewall 61 will commensurately inwardly collapse, as triggered by the inward collapse of secondary sidewall 71). In various embodiments, all four such auxiliary fold lines 68 may be in primary sidewalls 61 (as in the exemplary arrangement of FIG. 3); or, all four such auxiliary fold lines 68 may be in secondary sidewalls 71. Or a hybrid arrangement may be used e.g. with two auxiliary fold lines being in primary sidewalls 61 and two auxiliary fold lines being in secondary sidewalls 71.

In some embodiments, e.g. if corner-bonding tab 64 extends integrally from an end of primary sidewall 61 and is bonded to secondary sidewall 71, and an auxiliary fold line 68 is located in secondary sidewall 71, a portion of a corner-bonding tab 64 may overlie (e.g., inwardly overlie) an area of secondary sidewall 71 that is beyond auxiliary fold line 68 (in a direction generally away from the frame-corner 53 with which the corner-bonding tab 64 and the auxiliary fold line 68 are associated). In some such cases, bonding area 66 in which corner-bonding tab 64 is bonded to the inward surface of secondary sidewall 71, may be located between auxiliary fold line 68 and fold line 65. (In other words, bonding area 66 can be positioned between auxiliary fold line 68 and its associated frame-corner 53.) This can ensure that any portion of corner-bonding tab 64 that extends beyond auxiliary fold line 68 (in a direction generally away from the associated frame-corner) does not have to fold when secondary sidewall 71 folds along auxiliary folding line 68. Such an arrangement, in which the corner-bonding tab 64 does not hinder the folding of sidewall to which it is bonded, can make it easier to perform the frame-folding operation. Of course, in some embodiments a corner-bonding tab 64 may simply stop short of an auxiliary fold line 68, to achieve similar effects.

Further variations are possible. For example, a corner-bonding tab 64 may extend integrally from a secondary sidewall 71 rather than from a primary sidewall 61, and can consequently be bonded to a primary sidewall 61. In general, any combination of corner-bonding tabs 64 that extend from secondary sidewall 71 or from primary sidewall 61, along with auxiliary folding lines 68 that are located in secondary sidewall 71 or primary sidewall 61, can be used.

Other advantageous arrangements are possible. For example, perimeter frame 50 as shown in FIG. 4 comprises removable sections 82 that are connected (e.g., on all four sides) to other components of frame 50 (specifically, primary and secondary flanges 62 and 72 and central strut 81) by lines of weakness 83 that allow sections 82 to be detached from these components at a desired time. Any number of removable sections 82 may be provided, and can remain in position during production of frame 50 and during the process of forming a framed filter 1. Section(s) 82 can then be detached and removed (e.g. by an end-user) before framed air filter 1 is installed into a powered air-handling apparatus such as a room air purifier. In many embodiments, removable section(s) 82 may be located within the above-described second-side active air-filtration area 55 (strictly speaking, within what will become active air-filtration area 55 upon removal of section(s) 82).

The inclusion of removable sections 82 allows frame 50 to have a large semi-contiguous planar area on its second major side 52, on which can be disposed (e.g. by printing, attachment of pre-printed labels, etc.) product information, decorative indicia, barcodes, and so on. (Of course, information, decorative indicia, etc. may also be provided on the outer surfaces of the primary and secondary sidewalls of frame 50.) Such arrangements can minimize or eliminate any need for the framed air filter 1 to be installed into additional packaging that bears information and/or decorative indicia. Rather, in some embodiments a framed air filter 1 may merely comprise, consist, or consist essentially of, pleated filter element 10 and perimeter frame 50, e.g. with the framed air filter 1 wrapped in a transparent film through which the various informational and/or decorative indicia are visible.

Thus in some embodiments, removable sections 82 of frame 50 may remain in place until such time as they are removed e.g. by an end user (FIGS. 2 and 3 depict sections 82 as already having been removed; this is done for ease of presentation. Similarly, features such as corner-bonding tabs 64 and auxiliary fold lines 68 are omitted from FIG. 2, which is again done for ease of presentation.) To facilitate the removing of sections 82 by an end user, each such section 82 may be accompanied by one or more apertures 84 (in which any previously-present frame material has been removed, typically at the factory where the frame is manufactured). Such apertures 84 can provide easy access to a terminal edge 85 of a section 82 so that the removal of the section 82 can be initiated e.g. by an end-user.

In many convenient embodiments, a blank 60 from which a perimeter frame 50 is made, may be comprised of cellulosic paperboard (chipboard), of any suitable thickness that provides sufficient mechanical rigidity but that also allows (e.g. when provided with fold lines) the ability to form a foldable connection. In various embodiments, such paperboard may range from at least about 16, 18, 20, 22, or 24 thousandths of an inch in thickness, to at most about 62, 36, 34, 32, 30, or 28 thousandths of an inch in thickness. At least one side of the paperboard may comprise a decorative coating (such as white clay or other pigment) or layer if desired; for example, the paperboard may be so-called white-lined chipboard. In some embodiments, any such paperboard may be kraft paperboard; in some embodiments, such paperboard may be so-called SBS (solid-bleached-sulfate) paperboard. In some embodiments, some other sheet-like material (e.g. plastic sheeting of suitable composition) may be used rather than chipboard. In many embodiments, the frame material will be a single-layer material (e.g., any of the above-recited paperboards) rather than being a multilayer material such as corrugated paperboard or cardboard (such corrugated paperboards often comprise two flat linerboards with a fluted sheet therebetween). Thus in many embodiments, a perimeter frame 50 as disclosed herein will have primary and secondary sidewalls and primary and secondary second-side flanges that are all comprised of a single layer of frame material (excepting e.g. at corners where a corner-bonding tab is abutted against, and attached to, a sidewall, so that in this local area, two layers of frame material are present).

Fold lines may be formed in blank 60 by any suitable method. Such methods may include e.g. cut-scoring, crush-scoring, perforation, and so on. Such methods are described in detail e.g. in U.S. Pat. No. 11,376,537, which is incorporated by reference herein for the purpose of describing such methods. In some embodiments, fold lines 63, 73, and 65 may be formed by cut-scoring, while auxiliary fold lines 68 may be formed by perforating. However, in general, any method may be used to generate any fold line. Similarly, lines of weakness 83 (that allow an end user to detach and remove sections 82) may be formed by any suitable process. For example, the frame material may be cut completely through along some portions of lines 83, with remaining portions of lines 83 being e.g. perforated to allow the frame material to be easily separated along these portions. The through-cutting of frame material (e.g. to define the outer edges of the various panels of blank 60, and/or to remove frame material in designated areas to form apertures 84, and/or to define lines of weakness as discussed above), may be done by any suitable method, e.g. die-cutting (such as with rule dies and the like), laser-cutting, water-jet-cutting, and so on.

A suitably-cut blank may be formed into a perimeter frame by any suitable method and apparatus, whether relying on manual assembly, robotic assembly, or a combination of the two. As discussed earlier, in one simple incarnation, such a frame may be formed from a blank by folding various panels along fold lines 63, 65 and 73, and attaching a corner-bonding tab at an end of each sidewall, to a complementary bonding area near the end of a neighboring sidewall. Any suitable mechanical fastening method may be used (staples, grommets and so on) to perform any such attachment. Instead of this, or as an adjunct to this, any suitable adhesive (e.g. pressure-sensitive adhesives, hot-melt adhesives, photocurable adhesives, wood glues, rubber cements, and so on) may be used. Such frames, once made, can then be flattened and stored until such time as they are to be used to make framed air filters 1.

### Pleated Filter Element

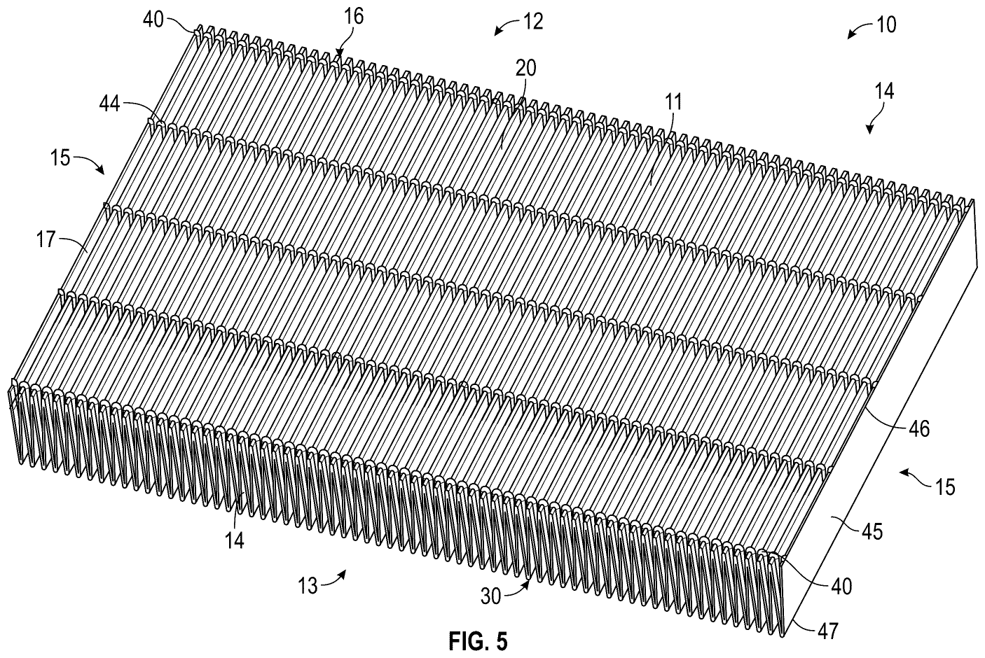

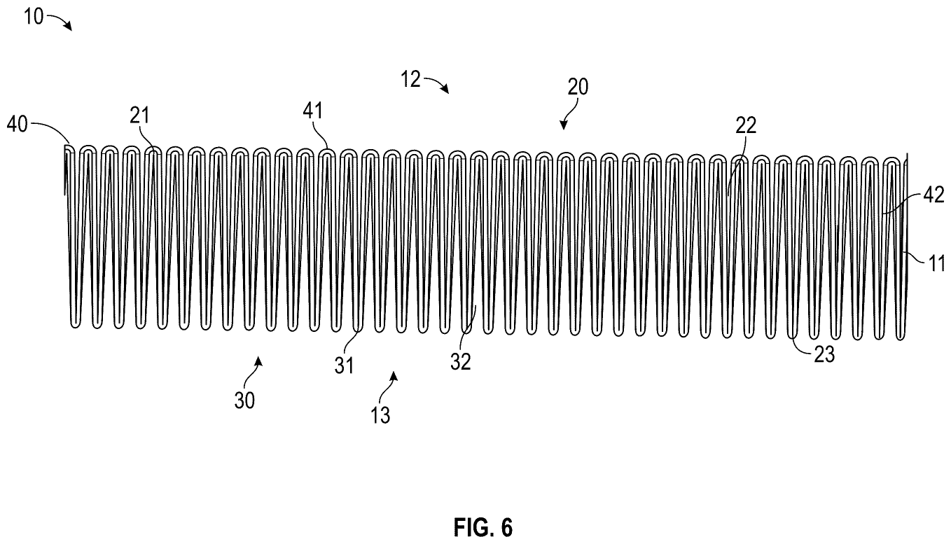

Framed air filter 1 comprises a pleated filter element 10. As shown e.g. in FIGS. 5 and 6, pleated filter element 10 comprises a filter media 11 that is formed (shaped) into a plurality of oppositely-facing first-side pleats 20 and second-side pleats 30. (First-side pleats 20 will be on the first major side 12 of the pleatpack, that bears a perimeter seal 90 as discussed in detail elsewhere herein.) Each first-side pleat 20 comprises a first-side pleat tip 21 and each adjacent pair of first-side pleats 20 defines a first-side pleat valley 22 therebetween. Second-side pleats 30 are in oppositely-facing configuration from first-side pleats 20. Each second-side pleat 30 comprises a second-side pleat tip 31 and each adjacent pair of second-side pleats 30 defines a second-side pleat valley 32 therebetween. As noted earlier, pleated filter element 10 comprises two opposing corrugated edges 14 and two opposing non-corrugated ends 15. (The term “corrugated” signifies that an edge exhibits a generally zig-zag appearance when viewed along the Pleat Direction (defined below) of the pleated filter element.)

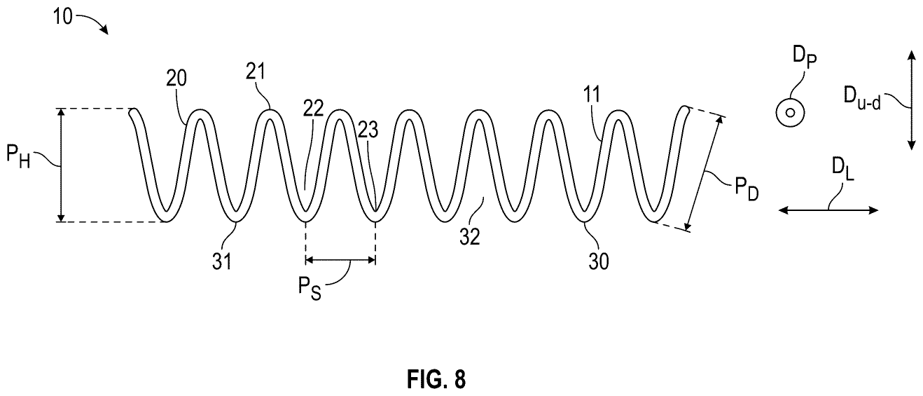

Further geometric properties of a pleated filter element 10 are indicated in the generic representation of FIG. 8. As used herein, the Pleat Direction (D_{P} in FIG. 8) is a direction that is aligned with the long axis of the pleat tips and that typically runs from one corrugated edge 14 to the other, opposing corrugated edge 14 of the pleated filter element. This Pleat Direction corresponds to the “lateral” direction of the pleatpack and of the framed air filter as a whole (this lateral direction is indicated in FIG. 1 as DA). The longitudinal direction (D_{L} in FIGS. 1 and 8) is a direction that is orthogonal to the Pleat Direction and that typically runs from one non-corrugated end 15 to the other non-corrugated end 15 of the pleated filter element. (Although the terms longitudinal and lateral are used herein for convenience of description, it is not necessary that the longitudinal dimension of pleated filter element 10 must be greater than the lateral (Pleat Direction) dimension of pleated filter element 10.) The upstream-downstream direction (D_{u-d} in FIGS. 1 and 8) is a direction extending through the filter element (and the framed air filter as a whole) from the first major side 12 to the second major side 13, that is aligned with the overall direction of air flow through the air filter.

Further details of pleat geometry are discussed with reference to the side view of FIG. 8, noting that FIG. 8 is a generic representation in which items such as edge seals 40 (present in other Figures), are omitted for clarity. The pleat height (pleat amplitude) is the distance (Pₕ in FIG. 8) from a first-side pleat tip 21 to a second-side pleat tip 31, along a direction that is orthogonal to the overall major plane of filter element 10 (i.e., along a direction that is aligned with the upstream-downstream direction D_{u-d} of the pleated filter element). In various embodiments, the pleat height of filter element 10 may be at least about 4, 6, 8, 10, 16, 28, or 34 mm. In further embodiments, the pleat height may be at most about 150, 100, 75, 60, 50, 45, 40, 35, 30, 25, 20, 15, 12, 10, 8, or 6 mm.

The pleat spacing (P_{S} in FIG. 8) is the distance between nearest-neighbor same-side pleat tips, along a direction that is aligned with the overall major plane of the filter element (i.e., along the longitudinal direction Dₗ of the filter element). A pleated filter element 10 may comprise any suitable pleat spacing. In various embodiments the pleat spacing may be at most about 25, 20, 15, 10, 8, 6, 4, 3, or 2 mm; in further embodiments the pleat spacing may be at least about 1, 2, 3, 4, 5, 6, 8, or 10 mm. The pleat distance (Pa in FIG. 3) is the shortest distance from one pleat tip to a nearest-neighbor pleat tip along the local direction of the pleated media. Pleated filter element 10 may comprise any suitable pleat distance (although, for any given pleated filter element, the pleat distance may be very close to, or slightly larger than, the pleat height).

In some embodiments the pleat tips of pleated filter element 10 may have an average radius of curvature that is less than about 3 mm (any such radius of curvature will be an “inner” radius of curvature, measured at the floor of the pleat valley that complements the pleat tip). In various embodiments, such pleats may comprise tips with an average radius of curvature of at most about 2.5, 2.0, 1.5, 1.0, or 0.5 mm. In some embodiments filter element 10 may be tightly pleated, meaning that the pleat tips exhibit a very small radius of curvature and the pleat spacing is very small, both in comparison to the pleat height. In various embodiments, a tightly pleated filter element 10 may exhibit a pleat tip radius of curvature that is less than about 2 mm, and/or a pleat spacing that is from 2 to 8 mm, and/or a pleat height that is from about 20 to 60 mm. In further embodiments, a tightly pleated filter element 10 may exhibit a pleat tip radius of curvature that is no greater than about 1 mm, a pleat spacing that is from 4.5 to 6.5 mm, and a pleat height that is from 25 mm to 45 mm. In some embodiments in which filter element 10 is tightly pleated, adjacent walls of pleats may be at least generally parallel to each other, by which is meant that the pleat walls are oriented within 10 degrees of each other (in the exemplary depiction of FIG. 6, the pleat walls are oriented at approximately 5 degrees relative to each other).

### Edge Seals

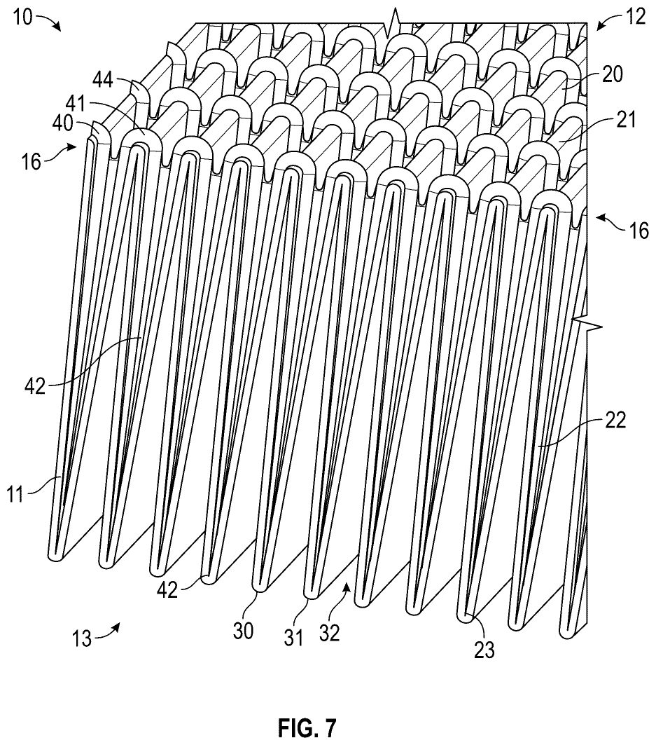

As seen most easily in the perspective views of FIGS. 5 and 7 and in the side view of FIG. 6, pleated filter element 10 comprises first and second edge seals 40. Each edge seal 40 is located proximate, and laterally inward from, a primary, corrugated edge 14 of the pleated filter element, as discussed in detail below, and is comprised of hardened adhesive. In many embodiments, such an adhesive may be provided as a liquid (e.g. a hot-melt adhesive heated to a suitable temperature) that is applied to the first major side of the pleated media as an elongate bead extending along the longitudinal direction of the media, proximate and laterally inward from a corrugated edge of the filter element. In some embodiments, the liquid adhesive may be applied to the pleated media with the media temporarily expanded along its longitudinal axis, after which the media may be compressed (with the adhesive still in an at least semi-liquid state) along the longitudinal direction of the media to a final pleated configuration that exhibits the desired final pleat spacing, pleat height, and so on. Upon hardening of the adhesive, the pleated media will be stably held in the desired pleated configuration. Any such edge seal will typically exhibit an elongate, e.g. linear, appearance (and will be aligned with the longitudinal direction of the media) when viewed along the upstream-downstream direction of the pleated filter element, as is apparent from various Figures.

As noted above, each edge seal 40 is located proximate, and laterally inward from, a primary, corrugated edge 14 of the pleated filter element 10. By this and like expressions (e.g. laterally inwardly proximate) is meant that the edge seal is located from 1 to 15 mm laterally inward (along the Pleat Direction D_{P}) from the corrugated edge. To achieve this, each edge seal may be produced by depositing a liquid adhesive bead onto the first major side of the media in the general manner described above, at a location that is from 1 to 15 mm laterally inward from the corrugated edge of the pleated media, and then longitudinally compressing the media to the final pleat spacing and allowing the adhesive to harden, again as described above. This will be contrasted with applying a liquid adhesive edgewise to a corrugated edge of a pleated filter media e.g. by dipping the corrugated edge of the pleated filter media in the liquid adhesive (so that the adhesive flows along the Pleat Direction of the pleated media). Thus, an edge seal that is laterally inwardly proximate a primary, corrugated edge of a pleated filter element in the manner described herein will not have any portion that extends laterally outward (along the Pleat Direction of the pleated media) beyond the corrugated edges of the pleated filter element. In various embodiments, each such edge seal may be located at a position that is recessed laterally inward (measured from the laterally-outward terminus of the corrugated edge of the pleatpack, to the centerline of the adhesive edge seal) a distance of from at least 1.0, 2.0, or 3.0, to at most 15, 10, 8, 6 or 4 mm.

The terminology of an edge seal thus denotes an elongate partition (that is aligned with the longitudinal direction of the pleated media) collectively provided by parcels of hardened adhesive that reside in successive first-side pleat valleys 22. In some embodiments, an adhesive parcel that is in a first-side pleat valley may not be in contact with an adhesive parcel that is in a nearest-neighbor first-side pleat valley (for example, the adhesive may be interrupted e.g. at the first-side pleat tips rather than being deposited as a continuous bead). However, in some embodiments, the parcels of adhesive in successive first-side pleat-valleys will be integrally connected to each other (as evident e.g. in FIGS. 5 and 7).

In many embodiments, the edge seal adhesive will at least substantially fill first-side pleat valleys 22 of the pleated filter element (e.g. at the above-denoted locations). That is, each parcel of adhesive may include a portion 42 (as denoted in FIG. 7) that extends substantially to the valley floor 23 of the pleat valley 22. This can be achieved, for example, by depositing the flowable adhesive in a configuration such that when the media is folded to its final pleated configuration, sections of the adhesive that are on opposing pleat walls of a pleat valley 22, come into contact with each other and merge to form portion 42 that extends between the opposing pleat walls and extends substantially to the valley floor 23. Each parcel of adhesive will thus substantially occlude the first-side pleat valley 22 in which it resides, meaning that at the location (along the pleat direction Dₚ) of the pleat valley where the parcel is positioned, the pleat valley is blocked so that at least substantially no air can flow therethrough generally along the pleat direction Dₚ. In some embodiments, similar edge seals may be provided on the second major side 13 of the pleated filter element 10 rather than only on the first major side 12 of the pleated filter element. However, in some embodiments, edge seals 40 will be provided only on the first major side 12 of the pleated filter element with no edge seals being present on the second major side 13 of the pleated filter element (as in the exemplary arrangements shown in FIGS. 5-7).

In some embodiments, at least portions 41 of an adhesive edge seal 40 may overlie, and protrude outward (i.e. in the upstream-downstream direction) beyond, the first-side pleat tips 21 of the pleated media, in the general manner most easily visible in the magnified view of FIG. 7. In some embodiments, portions 41 of an edge seal 40 may protrude outward beyond the first-side pleat tips 21 a distance of e.g. at least about 0.2, 0.5 or 1.0 mm. In some embodiments, portions 41 may protrude less than 3.0, 2.0, 1.5, 1.0, 0.5, or 0.2 mm outward beyond the pleat tips.

If desired, one or more interior adhesive dams 44 can be provided laterally in between the above-described edge seals 40, as visible in the exemplary arrangements shown in FIGS. 5 and 7. Although not necessarily needed for any occluding function, such interior dams 44 may enhance the mechanical rigidity of the pleated filter element, and/or may also assist in maintaining the pleats of the filter element in e.g. a tightly pleated configuration. Such interior dams 44 may be spaced at least generally uniformly across the lateral extent of the pleated filter element (as in the exemplary embodiment of FIG. 5), if desired. Or, such spacing may vary as desired. Any number of interior dams (e.g. one, two, three, four, or more) may be present (three such interior dams are depicted in FIG. 5). In some embodiments, any such interior dam(s) 44 may be disposed only on the first major side 12 of the pleated filter element 10. However, in some embodiments, interior dams may be provided on both major sides 12 and 13 of the pleated filter element. It may be convenient to provide first-side and second-side pairs of interior dams in a format in which they are aligned with each other (along the lateral direction of the pleatpack, i.e. along the Pleat Direction of the pleated media); however, in some embodiments the first-side and second-side interior dams may be offset from each other slightly along the Pleat Direction. Any such interior dams 44 may resemble edge seals 40 in general aspect (and may be made of the same flowable adhesive, e.g. deposited in the same adhesive-deposition operation), but do not necessarily need to substantially occlude the pleat valleys in which they reside. In fact, in some embodiments edge seals 40 may resemble interior dams 44 in many aspects, excepting that edge seals 40 may comprise a slightly greater volume of adhesive. This can ensure that edge seals 40 are able to perform their function of at least substantially occluding the first-side pleat valleys 22, while interior dams 44 can be present at a lower volumetric amount that is nevertheless still sufficient to, e.g., enhance the overall mechanical rigidity of the pleatpack. In various embodiments, the volumetric ratio of an edge seal 40 to an interior dam 44 may be at least 1.05, 1.10, 1.15, or 1.20. (This volumetric ratio may be obtained by measuring the volume of the edge seal, and the volume of the interior dam, in one or more selected first-side pleat-valleys 22.)

Edge seals 40 (and any interior dams 44 that may be present) are comprised of hardened adhesive. The term “adhesive” is used broadly to signify any material that can be deposited. e.g. as a bead, onto a major surface of pleated media 11 in a state (e.g., liquid, molten, softened, or semi-softened) in which the adhesive is sufficiently flowable or deformable that it can penetrate into pleat valleys to satisfactorily perform the functions disclosed herein. Any suitable material may be used, including e.g. hot-melt adhesives, UV-cure adhesives, thermally-cured adhesives, moisture-cure adhesives, and so on. In some embodiments, the adhesive may be a hot-melt adhesive that is deposited through e.g. conventional hot-melt deposition methods (e.g. by use of a grid melter), after which the adhesive is cooled to harden. The adhesive is not required to necessarily exhibit any pressure-sensitive adhesive functionality after being hardened; in other words, the adhesive may be a non-tacky, e.g. hard material after being hardened (e.g., when it has cooled to room temperature). As noted above, in some embodiments, edge seals 40 and interior dams 44 may be made of the same adhesive; however, in other embodiments, different adhesives may be used (for example, a lower-viscosity adhesive might be used for edge seals 40, in view of the desire to have the adhesive penetrate sufficiently into the first-side pleat valleys to at least substantially occlude them).

In at least some embodiments, the adhesive may be deposited as a bead that extends along the longitudinal direction of the pleated media, e.g. by passing the media underneath an adhesive-deposition nozzle or by moving the adhesive-deposition nozzle along the media. In some embodiments, such nozzles may be independently controllable so that, e.g. an adhesive bead that forms an edge seal 40 may be applied at a somewhat greater flowrate than an adhesive bead that forms an interior dam 44.

In some embodiments, the adhesive may be applied while the pleated media is held in a first, relatively open pleating pattern (that is, with a fairly large pleat spacing), with the pleated media then being compressed along its longitudinal axis to achieve the final (i.e. more tightly-spaced) pleating pattern, after which the adhesive is allowed to harden. In some embodiments, the media may not yet be pleated (but may have been scored or otherwise treated to render it pleatable) when the adhesive is applied; in other words, the adhesive may be applied when the media is in a generally flat configuration, after which the media is folded into a pleated configuration. In some embodiments, the filter media may be folded into a pleated configuration, and heat applied to the pleat tips to heat-set the pleat-tips (so that, once returned to this pleated condition, they tend to remain in the pleated condition), after which the filter media is temporarily unfolded to a fairly large pleat spacing (e.g., is unfolded almost flat), after which the adhesive is applied and the filter media is then refolded to its (now permanent) pleated condition at the desired pleat spacing, height, etc.

In some embodiments, the flow of adhesive through some or all of the adhesive-deposition nozzles can be periodically interrupted so as to leave one or more first-side pleat valleys 22 free of adhesive. This can be done for the edge seals 40 and for any first-side interior dams 44 that may be present. If any second-side interior dams are present, the adhesive that forms them may be similarly interrupted so as to leave one or more second-side pleat valleys 32 (e.g. that is a nearest-neighbor of an adhesive-free first-side pleat valley) similarly free of adhesive. In this manner, one or more first-side pleat valleys 22 (as well as one or more neighboring second-side pleat valleys 32) may be generally free of adhesive.

In some embodiments, such arrangements can be provided while the pleated media 11 is still in continuous (or quasi-continuous) form. Interrupting the adhesive in this manner can provide the continuous pleated media with intermittent sections that have one or more successive pleat valleys in which no adhesive is present. These adhesive-free sections (e.g. at a predetermined spacing along the longitudinal direction of the pleated media) can facilitate the cutting of the continuous media into individual pleatpacks. In other words, the media-cutting can be registered so that each cut occurs in an adhesive-free pleat valley. In some embodiments, each such intermittent adhesive-free section may comprise only a single pleat valley (e.g. a first-side pleat valley 22 defined by two pleat-panels that integrally meet at a first-side valley floor 23) that is adhesive-free, so that the pleated media can be cut in that pleat valley. However, in some embodiments, each such intermittent adhesive-free section may comprise multiple pleat valleys that are adhesive-free; e.g., two first-side pleat valleys 22 and a second-side pleat valley 32 therebetween; three first-side pleat valleys 22 and two second-side pleat valleys 32 interspersed therein; or four first-side pleat valleys 22 and three second-side pleat valleys interspersed therein. The cutting of the pleated media into individual pleatpacks may occur in any of the pleat valleys of each intermittent adhesive-free section.

Such arrangements will provide that one or both of the secondary, non-corrugated ends 15 of the resulting pleatpack 10 will have one or more pleat-panels that are not adhesively bonded to their nearest-neighbor pleat-panel by an edge seal or by an interior dam. As discussed in detail later herein, this can provide advantages in the process of inserting the pleatpack 10 into frame 50. In view of such arrangements, a first or second edge seal 40 may not necessarily extend along the entire longitudinal extent of the pleated filter element. Thus in various embodiments, a first or second edge seal may extend along 70, 80, 90, 95 or essentially 100% of the longitudinal extent of the pleated filter element (pleatpack). The same can hold for any interior dams 44 as might be present.

### Perimeter Seal

Framed air filter 1 as disclosed herein comprises a perimeter seal 90 that is disposed on the first major side 12 of pleated filter element 10. Perimeter seal 90 is comprised of hardened adhesive 99 (in some embodiments, the adhesive 99 may be of the same composition as that used to form edge seals 40) that is disposed generally along the perimeter of the first major side 12 of pleated filter element 10. A first function that is served by perimeter seal 90 is to adhesively bond the primary, corrugated edges 14 of pleated filter element 10 to the inward surface of the primary sidewalls 61 of frame 50; and, to adhesively bond the secondary, non-corrugated ends 15 of pleated filter element 10 to the inward surfaces of the secondary sidewalls 71 of pleated filter element 10. As such, after pleatpack 10 is initially seated within receptacle 54 of frame 50), adhesive 99 will be deposited (e.g. in a flowable form, e.g. in similar manner to that described above for forming an adhesive edge seal 40) so that it contacts at least the primary, corrugated edges 14 of pleatpack 10 and contacts the inward surfaces of primary sidewalls 61 of frame 50, so as to adhesively bond the primary, corrugated edges 14 of the pleatpack to the inward surfaces of the primary sidewalls 61 of the frame. In general, the adhesive 99 will be deposited onto primary corrugated edge regions 16 of the pleated filter element rather than just being deposited onto the lateral termini of the corrugated edges 14 (as might be the case if the corrugated edges 14 of a pleated filter element were dipped into an adhesive to apply the adhesive edgewise). It will be appreciated that this may cause portions of adhesive 99 to penetrate into the pleat valleys 22 of corrugated edge regions 16 to at least some extent.

Similarly, the adhesive 99 will be deposited so that it contacts at least the secondary, non-corrugated ends 15 of pleatpack 10 (and, in many embodiments, also contacts secondary, non-corrugated end regions 17) and contacts the inward surfaces of secondary sidewalls 71 of frame 50, so as to adhesively bond the secondary, non-corrugated edges of the pleatpack to the inward surface of the secondary sidewalls 71 of the frame. In other words, adhesive 99 will be deposited so that the thus-formed perimeter seal 90 comprises first and second primary sections 91 that extend along the two opposing primary, corrugated edges 14 (and edge regions 16) of the pleated filter element; and, first and second secondary sections 92 that extend along the two opposing, secondary, non-corrugated ends 15 (and end regions 17) of the pleated filter element. In many embodiments, primary sections 91 will extend along the entire longitudinal extent of pleated filter element 10 and secondary sections 92 will extend along the entire lateral extent of pleated filter element 10. All of these sections of perimeter seal 90 will be in contact with, and adhesively bonded to, various inward surfaces of sidewalls of frame 50, so that the pleated filter element is securely bonded to the frame (and vice versa). The resulting framed air filter 1 will exhibit a first-side active air-filtration area 48 that is longitudinally bounded by longitudinally-inward edges of secondary sections 92 of perimeter seal 90; area 48 will be laterally bounded by laterally-inward edges of primary sections 91 of perimeter seal and/or by edge seals 40. Incoming air will pass through first-side active air-filtration area 48 in order to enter pleated filter element 10.

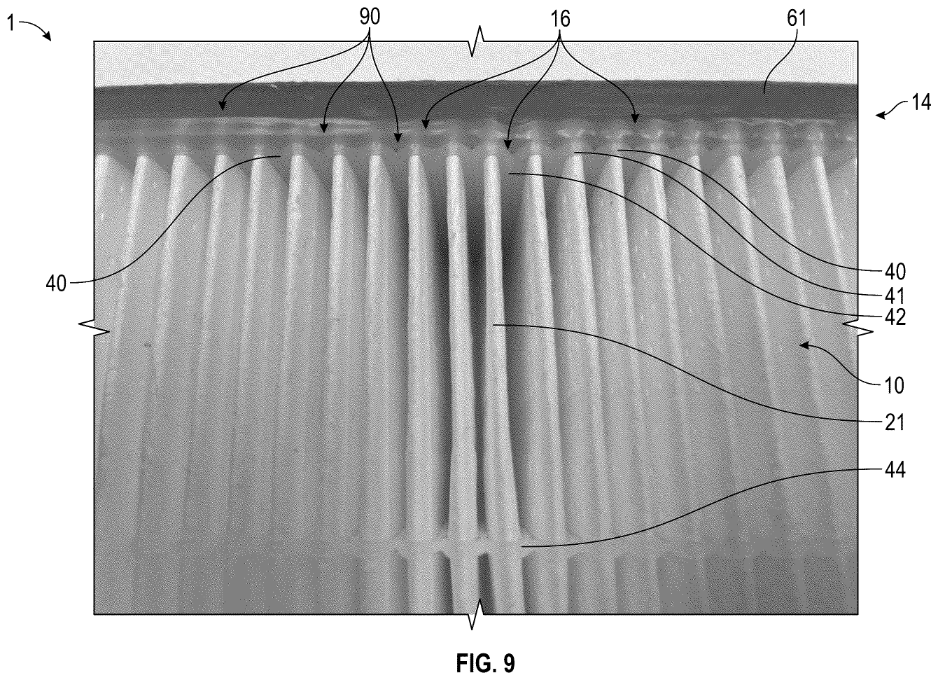

The above-described arrangements are depicted in FIG. 1. However, in FIG. 1 perimeter seal 90 is rendered transparent so that other features that underlie portions of perimeter seal 90 can be visualized. An actual perimeter seal 90 is shown in FIG. 9, which is a photograph of a first side of a prototype framed air filter 1 bearing a first-side perimeter seal 90. In FIG. 9, the above-described portions and features of perimeter seal 90, along with various other features (e.g. a frame primary sidewall 61, a first-side edge seal 40, a first-side interior dam 44, and so on) are indicated.

In some embodiments, pleated filter element 10 will be bonded to perimeter frame 50 only by way of a first-side perimeter seal 90 as described above. That is, in such embodiments, pleated filter element 10 will not be bonded or attached to perimeter frame 50 by any bonding or attachment mechanism other than a first-side perimeter seal 90. Thus in at least some such arrangements the second-side pleat tips 31 will not be attached (adhesively or otherwise) to second-side secondary flanges 72 of frame 50. Moreover, in at least some such arrangements the laterally-outward-facing lateral termini of the corrugated edges 14 of pleated filter element 10 will not be directly adhesively bonded to the inward surface of primary sidewalls 61 (as might be the case if the corrugated edges 14 of a pleated filter element were dipped into an adhesive or if the adhesive were coated as a layer on the inward surface of primary sidewalls 61).

Perimeter seal 90 can thus securely bond pleated filter element 10 to perimeter frame 50. In some embodiments, perimeter seal 90 can perform an additional function; namely, to enhance the stability of the previously-described corners 53 of perimeter frame 50. As discussed previously herein, a primary sidewall 61 can be secured to a secondary sidewall 71 to form and maintain a corner 53 of frame 50, e.g. by way of a corner-bonding tab 64 that extends from primary sidewall 61 and that has a bonding area 66 that is bonded to a bonding area 76 of secondary sidewall 71 by a parcel of adhesive, as depicted in FIG. 3. In order to augment such arrangements, corner-bonding tab 64 can comprise a cut-out area 67 (denoted in FIGS. 3 and 4) that is configured (sized and shaped) so that when corner-bonding tab 64 is abutted against secondary sidewall 71, an area 77 of secondary sidewall 71 remains uncovered by tab 64, as evident in FIGS. 3 and 4. When adhesive 99 is disposed on pleatpack 10 and frame 50 to form perimeter seal 90, adhesive 99 can be applied so that it is present on the inward surface of tab 64 and so that a portion 97 of adhesive 99 extends (upward, in the views of FIGS. 1 and 3, beyond a terminal upward edge of tab 64) so the adhesive in contact with the area 77 of secondary sidewall 71. The bonding of adhesive 99 to inward surface of tab 64 and to area 77 of secondary sidewall 71 will cause perimeter seal 90 to assist in holding tab 64 securely against secondary sidewall 71. (This thus augments the above-described bonding of tab 64 to secondary sidewall 71 by way of a bonding adhesive that is disposed between areas 66 and 76 of tab 64 and secondary sidewall 71.

In general, arrangements in which a corner-bonding tab 64 is provided with a cut-out area 67 that leaves an area 77 of a sidewall exposed so that perimeter seal adhesive 99 can bond to area 77 to more securely hold tab 64 against the sidewall, can be used with any of the previously-discussed frame configurations. For example, such arrangements can be used in cases in which a corner-bonding tab 64 extends integrally from a primary sidewall 61 and is bonded to a secondary sidewall 71 (as described above), and can also be used in cases in which a corner-bonding tab 64 extends integrally from a secondary sidewall 71 and is bonded to a primary sidewall 71. Such arrangements can also be used regardless of whether auxiliary folding lines are present in primary sidewalls 61 and/or in secondary sidewalls 71.

As discussed earlier herein, to make a framed air filter 1, pleatpack 10 may be inserted into receptacle 54 of frame 50 in the general manner depicted in FIG. 3. In some embodiments, the secondary, non-corrugated ends 15 of pleatpack 10 will have been formed by cutting a longer length of pleated media 11 to form individual pleatpacks 10 in the manner previously described. In some embodiments, these secondary, non-corrugated ends 15 may be oriented so that the insertion of pleatpack 10 into frame 50 can be more easily accomplished. Specifically, pleatpack 10 may be readied for insertion, in a configuration such that the terminal edge 46 of the endmost pleat-panel 45 faces away from frame 50 and the endmost pleat tip 47 (at which endmost pleat-panel 45 meets its neighboring pleat-panel) faces toward frame 50, as in the depiction of FIG. 2. (Terminal edge 46 will thus be on the first side of the pleatpack and resulting framed air filter, and endmost pleat tip 47 will be on the second side of the pleatpack and resulting framed air filter.)

Such an arrangement can make it easy to slidably insert pleatpack 10 into receptacle 54 of frame 50 without the terminal edge 46 of the endmost pleat panel 45 snagging on the secondary sidewall 71 of frame 50. Insertion in this configuration will also cause the terminal edge 46 of the endmost pleat-panel 45 to flare outward toward the inward surface of secondary sidewall 71. This can ensure that terminal edge 46 of endmost pleat-panel 45 (and, often, closely-adjacent areas of endmost pleat-panel 45) is positioned very close to (e.g., is in contact with) the inward surface of secondary sidewall 71. This will allow terminal edge 46 to be easily adhesively bonded to the inward surface of secondary sidewall 71 in the process of forming perimeter seal 90.

As mentioned earlier herein, in some embodiments one or more pleat-panels in secondary end region 17 of pleated filter element 10 (e.g., the above-described end pleat-panel 45 and one or more of its nearest-neighbor pleat-panels) may be omitted from the process of forming edge seals 40 (and any interior dams 44, if present). Such pleat-panels, not being restricted by the presence of edge seal adhesive or interior dam adhesive, will have more freedom of movement to be “gathered” together and/or expanded apart from each other. Such arrangements (which may be provided in one or both secondary end regions 17 of pleatpack 10) can provide that the secondary ends 15 of pleatpack 10 are more easily able to adjust to any slight variations in the fit of pleatpack 10 into frame 50. For example, such arrangements can provide that at least an end pleat-panel 45, and in some cases multiple (e.g. two or three) gathered pleat-panels including end pleat-panel 45, will tend to become abutted against the inward surface of secondary sidewall 71 of frame 50 upon insertion of the pleatpack into the frame. This can ensure that the above-described secondary region 92 of perimeter seal 90 is easily able to bond secondary end 15 of pleatpack 10 to secondary sidewall 71 of frame 50.

To further promote such arrangements, in some embodiments, the longitudinal dimension of frame 50 may be slightly undersized relative to the nominal longitudinal dimension of pleatpack 10. In such a case, the adhesive-free end pleat-panels of the pleatpack may be temporarily gathered (compacted together) for insertion of pleatpack 10 into frame 50. After insertion, the end pleat-panels can be slightly expanded, or allowed to expand, so that at least end-pleat panel 45 is in contact with secondary sidewall 71 of frame 50 (noting that in some embodiments, the pleated filter media may be made of a material such that the gathered pleat-panels exhibit an inherent tendency to expand when free to do so). Any such arrangements can ensure that the secondary ends 15 of pleatpack 10 are positioned so that subsequently-applied secondary sections 92 of perimeter seal 90 can securely bond the secondary ends 15 of pleatpack 10 to secondary sidewall 71 of frame 50 in a substantially occlusive manner. Any such pleat valleys as may lack an edge seal may typically remain at least slightly gathered at the secondary end of the pleatpack and in any event will typically be covered by the perimeter seal as discussed below. This being the case, the absence of edge seal adhesive parcels in such pleat valleys has not been found to cause any problems e.g. in terms of air leakage.

### “Substantial” Occlusion

Perimeter seal 90, e.g. as depicted in FIG. 1, has been referred to throughout this disclosure as being a “seal”. This is because perimeter seal performs another function in addition to the above-discussed roles of adhesively bonding pleated filter element 10 to perimeter frame 50 and assisting in bonding the corner-bonding tabs of some sidewalls of the frame, to other sidewalls of the frame. Specifically, a perimeter seal 90 as defined herein will be deposited on the perimeter of pleated filter element, and configured, to form a substantially occlusive seal. In particular, primary sections 91 of perimeter seal 90 will be disposed on corrugated edge regions 16 (denoted e.g. in FIGS. 5 and 9) of pleated filter element 10. Expanding on the discussion of corrugated edge regions 16 provided earlier herein, a corrugated edge region 16 is a region of the first major side 12 of pleated filter element 10 that is adjacent a corrugated edge 14 of pleated filter element 10 and that is laterally inwardly bounded by an edge seal 40 that is located laterally inward of the corrugated edge 14. Primary section 91 of perimeter seal 90 will be adhesively bonded to the inward surface of primary sidewall 61, will completely cover corrugated edge region 16, and will be adhesively bonded to edge seal 40, in a manner that provides at least substantial occlusion of corrugated edge region 16, as illustrated in FIG. 9. (In some embodiments, laterally-inward portions of section 91 of perimeter seal 90 may overlap edge seal 40 such that some areas of section 91 end up laterally inward of edge seal 40.)

Primary section 91 of perimeter seal 90 substantially occlusively overlies corrugated edge region 16 of pleated filter element 10 and thus substantially prevents air that impinges on corrugated edge region 16 from entering the pleat valleys of corrugated edge region 16 along an upstream-downstream direction. Edge seal 40, in turn, will substantially prevent any air from flowing laterally along the pleat valleys of the first side of the pleated filter element so as to be able to enter the pleat valleys of corrugated edge region 16 along a laterally-outward pathway. Sections 91 of perimeter seal 90, and edge seals 40, thus act in combination to provide substantially air-tight occlusion at the primary, corrugated edges 14 (and edge regions 16) of the pleated filter element 10, so as to substantially eliminate any ability for air to leak through or around the corrugated edge regions of the pleated filter element of the framed air filter.

Perimeter seal 90 will also comprise secondary sections 92 that adhesively bond secondary, non-corrugated ends 15 (and, typically, secondary, non-corrugated end regions 17) of pleated filter element 10 to the inward surfaces of secondary sidewalls 71. Sections 92 will similarly provide a substantially occlusive seal so that flowing air that impinges on the first side of framed air filter 1, cannot leak around the non-corrugated ends 15 of pleated filter element 10. Sections 92 of perimeter seal 90 will meet with sections 91 of perimeter seal 90 (and be adhesively bonded thereto) at the four corners of the pleated filter element 10 to ensure that these corners are likewise substantially occluded. Perimeter seal 90 thus acts (in combination with edge seals 40) to ensure that air is substantially unable to leak around the corrugated edges 14 nor around the non-corrugated ends 15, of pleated filter element 10. The arrangements disclosed herein thus allow a pleatpack to be installed in a perimeter frame in a simple process (e.g., inserting the pleatpack into the (unfolded) perimeter frame, and disposing an adhesive around the four edges of the pleatpack to form a first-side perimeter seal), which results in the pleatpack being securely attached to the perimeter frame and in all of the edges of the pleatpack being substantially occlusively sealed against air leaks.

Adhesive 99 may be disposed around the four edges of pleatpack 10 to form perimeter seal 90 in any suitable manner. In some embodiments, adhesive 99 may be a hot-melt adhesive that is brought to an at least semi-molten condition in which it can be dispensed, after which adhesive 99 is allowed to harden to form perimeter seal 90. Adhesive 99 may be dispensed robotically, manually, or any combination thereof. In some embodiments, an adhesive 99 that is used to form perimeter seal 90 may be of the same composition as an adhesive that is used to form edge seals 40. This may enhance the aggressiveness with which the perimeter seal bonds to the edge seal; however, in general, the use of identical compositions for these two adhesives has not been found to be necessary in order to attain an adequate bond.

Throughout this disclosure, the terminology has been used of “substantial” occlusion, a “substantially” occlusive seal, “substantial” sealing against air leaks, and so on. This terminology is used in view of the fact that any real-life process such as the deposition of an adhesive 99 along the edges of a pleatpack 10 will be subject to inevitable slight statistical variations; thus, the resulting perimeter seal 90 may comprise occasional tiny through-passages (e.g. “pinhole” leaks). Therefore, the terminology of “substantial” occlusion is defined herein so as to not require a “perfect” (hermetic) seal through which no air whatsoever can penetrate. Rather, the presence of a small number of e.g. pinhole leaks, through-passages, etc. is permitted. In fact, prototype framed filters made in the general manner described herein, in which a perimeter seal was made by robotic deposition of adhesive 99, starting in one corner and traversing around the four sides of the pleatpack and arriving back at the initial corner, have been found to occasionally exhibit a small through-passage at the initial corner, where the last-deposited parcel of adhesive 99 meets the first-deposited parcel of adhesive 99. While it is possible that this phenomena may be eliminated e.g. by varying the process conditions (e.g. the deposition speed and/or volume of adhesive 99), such through-passages have not been observed to affect the filtration performance of the resulting framed filter 1 in a material way. This is particularly true if the resulting framed filter 1 is used in a recirculating mode such as e.g. when used in a room air purifier. (The reason that occasional small leaks do not significantly affect filtration performance in recirculating mode are discussed e.g. in paragraphs 0024-0025 of U.S. Patent Application Publication 2024/0149198, which is incorporated by reference in its entirety herein.)

### Filter Media

Pleated filter element 10 may be made from, or comprise, any suitable filter media 11 and may be configured to filter (e.g., capture) particles, vapors, or gases, or any combination thereof. Potentially suitable materials may include e.g. paper; porous films of thermoplastic or thermoset materials; microporous membranes such as phase-inversion membranes, organic polymeric nonwoven webs (such as melt blown or spunbond webs, carded webs, wet-laid or air-laid webs, and so on) of synthetic or natural fibers; scrims; woven or knitted materials; foams; fiberglass media; or laminates or composites of two or more materials. A nonwoven organic polymeric web comprised of polyethylene, polypropylene or poly (lactic acid) may be suitable, for example. Any suitable method of making a nonwoven web (e.g., melt-blowing, melt-spinning, carding, and so on) may be used.

In specific embodiments, filter media 11 may have at least one layer that comprises an electret material. By an electret material is meant a material (e.g. an organic polymeric material) that, after a suitable charging processes, exhibits a quasi-permanent electric charge. Such a material may be chosen from any suitable material, e.g. split fibrillated charged fibers as described in U.S. Pat. No. RE 30782. Such charged fibers can be formed into a nonwoven web by any suitable means and can be optionally joined to a scrim such as disclosed in U.S. Pat. No. 5,230,800. In other specific embodiments, filter media 11 can be a melt blown microfiber nonwoven web (e.g. of the general types disclosed in U.S. Pat. Nos. 4,215,682 and 7,989,371) or a spunbond nonwoven web, that may include at least some fibers that comprise electrets. Such a web can optionally be joined to a secondary layer during web formation, or subsequently joined to a secondary layer in any conventional manner if desired. Filter media that may be particularly suitable for certain applications might include e.g. media of the general type described in U.S. Patent Application Publication 20080038976 to Berrigan; media of the general type described in U.S. Patent Application Publication 20040011204 to Both; and media generally known as tribocharged media. Nonwoven webs which may be used as, or as a layer, of, the filter media can be a high loft spunbond web, such as described, for example, in U.S. Pat. No. 8,162,153. In some embodiments, the filter media can be, or include, a low loft spunbond web, such as those described in U.S. Pat. No. 7,947,142.

Any such chargeable media can thus be treated or otherwise processed to include charged electret moieties. Any suitable charging method may be used, chosen from e.g. corona charging, hydrocharging, tribocharging, and so on. In some embodiments, a filter media may be formed from pre-charged electret fibers; or, a filter media may be formed (e.g. collected as a nonwoven web and consolidated if desired, or formed into a membrane) and then post-charged. If desired, the media may comprise one or more charging additives, e.g. chosen from any of the additives described in International Patent Publication WO2016/033097. Pleats can be formed in the filter media using various methods and components as are well known in the art, for example those described in U.S. Pat. Nos. 6,740,137 and 7,622,063. In particular embodiments, filter media 11 may comprise, or consist of, a multilayer nonwoven web that comprises a spunbond layer and a meltblown layer, e.g. with both layers comprising electrets. In some such embodiments, the spunbond layer may provide at least some filtration in addition to imparting stiffness that enhances pleatability. In some embodiments, filter media 11 may comprise a meltblown layer that comprises electrets, along with an uncharged spunbond layer or staple fiber layer (which, in such embodiments, may serve primarily to provide stiffness and pleatability).

In various embodiments, any such filter media 11 may exhibit a thickness of less than about 2.0, 1.5, 1.2, 1.0, 0.8, 0.6, 0.5, or 0.4 mm. In various embodiments, any such filter media 11 may exhibit a basis weight of from at least about 10, 20, or 30 grams per square meter (g/m²), to at most about 180, 140, 120, 100, 80, or 60 g/m². In various embodiments, the media may exhibit a pressure drop that is greater than about 0.5, 1.0, 2.0, 4.0, or 8.0 mm of water. In further embodiments, the media may exhibit a pressure drop that is less than about 20, 15, or 10 mm of water. In various embodiments, the media may exhibit a Percent Penetration (at a face velocity of 14 cm/s) of less than about 50, 20, 10, 5.0, 2.0, 1.0, 0.4, 0.2, 0.1, 0.05, or 0.03 (e.g., the media may exhibit HEPA filtration). In various embodiments, the media may exhibit a Quality Factor of at least 0.3, 0.6, 1.0, or 1.4. Percent Penetration and Quality Factor can be evaluated according to the apparatus and procedures outlined in U.S. Pat. No. 8,162,153, which is incorporated by reference in its entirety herein.

In some embodiments, one or more external gaskets (not shown in any Figure) may be provided along at least a portion of (e.g. completely around) the outward-facing surfaces of the primary and secondary sidewalls 61 and 71 of perimeter frame 50. Such an external gasket, if present, may be e.g. permanently attached to frame 50. Such a external gasket may be made of a resilient polymeric material such as rubber, silicone, or the like. The polymeric material may be solid, or may be a foam. If a foam, it may be an open-cell foam, or a closed cell foam. In some embodiments, no such external gasket is present, it being found that in general, if the arrangements disclosed herein are used, no such external gasket is needed in order to achieve excellent performance e.g. in a room air purifier.

In some embodiments, framed air filter 1 may be the only air-filtering item that is installed in a powered air-handling apparatus such as e.g. a room air purifier. However, in other embodiments, one or more layers of air-filtering material may likewise be installed within the apparatus, e.g. in the form of a pre-filter that is abutted against the upstream major side of framed air filter 1. Such a layer or layers may contain one or more materials that interact with an airstream to at least partially remove one or more components (e.g., gases, vapors, odors, solid particles, aerosols, and so on) therefrom. Potentially suitable materials for such uses include e.g., activated carbon; alumina and other metal oxides; sodium bicarbonate; metal particles (e.g., silver particles) that can remove a component from a fluid by adsorption, chemical reaction, or amalgamation; catalytic agents such as hopcalite and/or gold (which can catalyze the oxidation of carbon monoxide); clay and other minerals treated with acidic solutions such as acetic acid or alkaline solutions such as aqueous sodium hydroxide; ion exchange resins; molecular sieves and other zeolites; silica; biocides; fungicides and virucides.

In many embodiments, when framed air filter 1 is installed into a powered air-handling apparatus, flowing air, as motivated by the powered air-handling apparatus, will approach framed air filter 1, and will exit air filter 1, along a direction that is at least generally aligned with the upstream-downstream direction D_{u-d} of the filter. Such a direction will often be at least generally orthogonal to the Pleat Direction Dₚ of the pleated filter element 10, as evident from FIG. 8. Thus, in ordinary use of a framed air filter 1, there may often be little or no airflow along the long axis of the pleat valleys of the pleated media (i.e., along the Pleat Direction D_{P}). In particular, framed air filter 1 is distinguished from filter arrangements in which a fluid flows along pleat valleys in between multiple layers (e.g., stacks or wraps) of pleated media. Framed air filter 1 is thus distinguished from e.g. so-called spiral-wound filters and the like that, as supplied, comprise multiple layers of filter media and in which substantial fluid flow occurs along the long axis of the valleys in between layers of the pleated media. In at least some embodiments, pleated filter element 10 will include only a single layer of pleated media 11 (although pleated media 11 itself may be a multilayer material) rather than including a stack or wrap of multiple layers of media. In particular embodiments, framed air filter 1, and pleated filter element 10 thereof, will exhibit an overall shape that exhibits an identifiable major plane (as readily apparent in FIGS. 1, 2, 5 and 6). That is, framed air filter 1 and pleated filter element 10 thereof will not be arcuate. Rather, framed air filter 1 will exhibit an overall radius of curvature (discounting local variations due to the pleats) approaching infinity. Thus in at least some embodiments, framed air filter 1 is not a cylindrical (e.g. a cylindrical-cartridge) filter.

Framed air filter 1 may be used in any powered air-handling apparatus that is desired to be used to filter air. In various embodiments, framed air filter 1 can be used in room air purifiers, heating-ventilation-air-conditioning (HVAC) systems (whether centralized systems or so-called mini-split systems), cabin air filters for vehicles, filters for internal combustion engines, and so on. The arrangements disclosed herein can allow a framed air filter to be simply and inexpensively constructed and can allow the framed air filter to be installed e.g. into a room air purifier so that excellent filtration performance can be achieved. In particular, a framed air filter as disclosed herein need not be inserted into any additional housing, cartridge, or the like, in order to be installed in a powered air handling apparatus. Rather, the framed air filter can simply be inserted into an air-filter-receptacle of the apparatus. In many embodiments, the framed air filter may be installed so that the above-described first side of the framed air filter is the upstream side (upon which airflow impinges). However, since the herein-described arrangement of edge seals and a perimeter seal will function to prevent airflow around the edges and ends of a pleated filter element regardless of the airflow direction, in some embodiments a framed air filter as disclosed herein can be installed so that the second side of the framed air filter is the upstream side.

Installation of framed air filter 1 in a powered air-handling apparatus such as a room air purifier (along with ancillary activities such as detaching and removing any removable sections 82 from the frame of the framed air filter) can be performed by any end-user. The term end-user is used broadly and is not limited to, e.g. an owner of a powered air-handling apparatus. Rather, an end-user might be e.g. a maintenance technician, service worker, custodian, and so on.

A framed air filter as disclosed herein will not necessarily require any additional elements or components in order to function. Thus in various embodiments, a framed air filter as disclosed herein may consist, or consist essentially of, a pleated filter element with edge seals (and with one or more optional interior adhesive dams), a perimeter frame of the general type described herein, and a perimeter seal that attaches the framed air filter to the perimeter frame and that serves (in combination with the edge seals) to prevent air leakage around the four sides of the pleated filter element. The terminology of “consist essentially of” allows ancillary components such as e.g. labels, wrapping or packaging, and so on, but precludes any additional components that would materially affect the functioning of the framed air filter.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document mentioned and/or incorporated by reference herein, this specification as written will control.

What is claimed is:

1. A framed air filter comprising:
a flattenable-as-made, single-piece perimeter frame comprising first and second opposing primary sidewalls, first and second opposing secondary sidewalls, first and second primary flanges that are located on a second major side of the perimeter frame and that respectively extend integrally inward from the first and second opposing primary sidewalls, and first and second secondary flanges that are located on the second major side of the perimeter frame and that respectively extend integrally inward from the first and second opposing secondary sidewalls;
a pleated filter element with a first major side and a second major side and comprising a plurality of oppositely-facing pleats with a pleat direction and with a plurality of first-side pleat tips and first-side pleat valleys and a plurality of second-side pleat tips and second-side pleat valleys;
wherein the pleated filter element comprises a first primary, corrugated edge and a second primary, corrugated edge; and, a first secondary, noncorrugated edge and a second secondary, noncorrugated edge;
wherein the first major side of the pleated filter element comprises:
a first edge seal of hardened adhesive that is located laterally inwardly proximate the first primary, corrugated edge of the pleated filter element and that extends along at least 80% of a longitudinal extent of the pleated filter element and that at least substantially occlusively occupies first-side pleat valleys of the first major side of the pleated filter element; and
a second edge seal of hardened adhesive that is located laterally inwardly proximate the second primary, corrugated edge of the pleated filter element and that extends along at least 80% of the longitudinal extent of the pleated filter element and that at least substantially occlusively occupies first-side pleat valleys of the first major side of the pleated filter element;
and,
a first-side perimeter seal that is disposed on a first major side of the framed air filter and comprises first and second primary sections that respectively adhesively bond the first and second primary corrugated edges of the pleated filter element to inward surfaces of the first and second primary sidewalls of the perimeter frame and first and second secondary sections that respectively adhesively bond the first and second secondary noncorrugated edges of the pleated filter element to inward surfaces of the first and second secondary sidewalls of the perimeter frame,
wherein the first and second primary sections of the first-side perimeter seal respectively extend along first and second primary, corrugated edge regions of the pleated filter element, and are respectively adhesively bonded to the first edge seal and the second edge seal,
wherein the first and second primary sections of the first-side perimeter seal of the framed air filter and the first and second edge seals of the pleated air filter element at least substantially occlusively seal the first and second primary, corrugated edges of the pleated filter element,
and wherein the first and second secondary sections of the first-side perimeter seal of the framed air filter substantially occlusively seal the first and second secondary, non-corrugated edges of the pleated filter element.

2. The framed air filter of claim 1 wherein the pleated filter element is attached to the perimeter frame solely by way of the first-side perimeter seal, with no other attachment means or mechanism being used to attach the pleated filter element to the perimeter frame.

3. The framed air filter of claim 1 wherein the first and second primary sections of the first-side perimeter seal respectively overlie, and at least substantially occlude, the first and second primary, corrugated edge regions of the pleated filter element.

4. The framed air filter of claim 1 with the proviso that the second major side of the pleated filter element does not comprise any edge seals.

5. The framed air filter of claim 1 wherein the pleated filter element comprises at least some first-side interior adhesive dams and at least some second-side interior adhesive dams.

6. The framed air filter of claim 1 wherein the pleated filter element comprises an filter media that is a multilayer media comprising a spunbond web layer and a meltblown web layer, each of which comprises spunbonded electret fibers.

7. The framed air filter of claim 1 wherein the pleated filter element exhibits a pleat spacing of from 3.0 millimeters to 7.0 millimeters and a pleat height of from 40 millimeters to 50 millimeters.

8. The framed air filter of claim 1 wherein the first secondary sidewall of the perimeter frame comprises first and second auxiliary fold lines at opposing ends of the first primary sidewall, each auxiliary fold line originating from a corner of the perimeter frame and extending diagonally along the first secondary sidewall to a first-side terminal edge of the first secondary sidewall; and
wherein the second secondary sidewall of the perimeter frame comprises first and second auxiliary fold lines at opposing ends of the second secondary sidewall, each auxiliary fold line originating from a corner of the perimeter frame and extending diagonally along the second secondary sidewall to a first-side terminal edge of the second secondary sidewall.

9. The framed air filter of claim 1 wherein laterally-inward terminal edges of the first and second primary flanges and longitudinally-inward terminal edges of the first and second secondary flanges, collectively define an active air-filtration area of the second major side of the framed air filter, through which area air will pass when exiting the second major side of the pleated filter element, when the framed air filter is installed in an operating powered air-handling apparatus.

10. The framed air filter of claim 9 wherein the second major side of the perimeter frame comprises at least one removable section that is connected other components of the perimeter frame, including at least a primary flange of the perimeter frame and a secondary flange of the perimeter frame, by lines of weakness that allow the at least one removable section to be detached from the other components of the perimeter frame by an end-user; and, wherein the removing of the at least one removable section exposes the entirety of the active air-filtration area of the second major side of the framed air filter.

11. The framed air filter of claim 10 wherein the at least one removable section of the second major side of the perimeter frame comprises two removable sections; and, wherein the removing of the two removable sections leaves in place, on the second major side of the perimeter frame, a strut that integrally extends from at least one primary or secondary flange of the perimeter frame and that extends across at least a portion of the active air-filtration area of the second major side of the perimeter frame.

12. The framed air filter of claim 10 wherein the at least one removable section of the second major side of the perimeter frame is accompanied by one or more through-apertures positioned adjacent the at least one removable section and configured so that a terminal edge of the at least one removable section is exposed for grasping by an end user to initiate removal of the at least one removable section.

13. The framed air filter of claim 9 wherein a first major side of the perimeter frame does not comprise any primary flanges or secondary flanges, and wherein laterally-inward edges of the first and second primary sections of the first-side perimeter seal and longitudinally-inward edges of the first and second secondary sections of the first-side perimeter seal combine to define an active air-filtration area of the first side of the framed air filter, through which area air will pass to enter the first major side of the pleated filter element when the framed air filter is installed in an operating powered air-handling apparatus.

14. The framed air filter of claim 1 wherein each of the primary sidewalls comprises corner-bonding tabs that extend integrally from each end of the primary sidewall and are connected thereto by a fold line, and wherein each corner-bonding tab of each primary sidewall is adhesively bonded to a secondary sidewall to form a corner of the perimeter frame, by an adhesive that is disposed between an outward surface of the corner-bonding tab and an inward surface of the secondary sidewall.

15. The framed air filter of claim 14 wherein each corner-bonding tab comprises a cut-out portion and wherein the perimeter seal is configured to have a portion that is adhesively bonded to an inward face of the corner-bonding tab and another portion that extends beyond a terminal edge of the corner-bonding tab so as to be adhesively bonded to the inward surface of the secondary sidewall.

16. A method of making the framed air filter of claim 1, the method comprising;
receiving the flattenable-as-made, single-piece perimeter frame in a flattened condition;
unfolding the perimeter frame into an open configuration in which the perimeter frame defines a filter-element-receiving receptacle within the perimeter frame;
inserting the pleated filter element into the receptacle of the perimeter frame;
and,
dispensing a flowable adhesive along a perimeter of a first major side of the pleated filter element and allowing the flowable adhesive to harden to form the first-side perimeter seal.

17. The method of claim 16 wherein the pleated filter element is inserted into the receptacle of the perimeter frame with the pleated filter element oriented so that a terminal edge of an endmost pleat-panel of the pleated filter element faces away from the perimeter frame and so that an endmost pleat tip of the pleated filter element faces toward the perimeter frame, so that the terminal edge of the endmost pleat-panel is on the first major side of the framed air filter and the endmost pleat tip is on the second major side of the framed air filter.

18. The method of claim 16 wherein no other bonding or attaching mechanism is used to attach the pleated filter element to the perimeter frame, other than the first-side perimeter seal.

19. A method of purifying air, the method comprising:
inserting the framed air filter of claim 1 into a framed-air-filter receptacle of a powered air-handling apparatus, so that the first major side of the framed air filter is an upstream side of the framed air filter;
and,
operating the powered air-handling apparatus so that air is drawn through the framed air filter and filtered thereby.

20. The method of claim 19 wherein the powered air-handling apparatus is a room air purifier or a heating-ventilation-air-conditioning system.
